(19) United States
(12) Patent Application Publication
(10) Pub. No.: US 2014/0189168 A1
(43) Pub. Date: Jul. 3, 2014

(54) HARD DISK DRIVE MODULE HAVING INDICATING DEVICE

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: GUO-YI CHEN, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/097,217

(22) Filed: Dec. 4, 2013

(30) Foreign Application Priority Data
Dec. 27, 2012 (CN) 2012105776912

(51) Int. Cl. G06F 3/06

(52) U.S. Cl. CPC G06F 3/0653; G06F 3/0604; G06F 3/0673
USPC 710/19

(57) ABSTRACT

A hard disk drive module comprises a hard disk drive, a bracket to support the hard disk drive, and an indicating device. The indicating device indicates a working status of the hard disk drive. The indicating device comprises an indicating unit and a processor. The processor is electrically connected to a control system via a cable to encode a status message transmitted by the control system, and controls the indicating unit to indicate the working status of the hard disk drive.

### BACKGROUND

1. Technical Field

The disclosure relates to a hard disk drive module, and particularly to a hard disk drive module using an indicating device for indicating a working status of the hard disk drive module.

2. Description of Related Art

Electronic devices, such as computers and servers, can have a plurality of hard disk drive modules to provide a large amount of data storage space for the electronic device. Many electronic devices are equipped with more than two hard disk drives, and indicators are provided to indicate a working status of each hard disk drive. Generally, plastic light pipes of the electronic devices are used to guide light emitted from the indicators to a location visible to a user. However, the plastic light pipes increase a cost of the electronic devices. In addition, because light beams from different plastic light pipes can interfere with each other, a design of the plastic light pipes is rather complicated and inefficient.

Therefore, what is needed is a means to overcome the above-described shortcomings.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is an isometric view of an embodiment of a hard disk drive module having an indicating device.

FIG. 2 is a schematic circuitry diagram of the indicating device of the hard disk drive module of FIG. 1.

### DETAILED DESCRIPTION

Reference will be made to the drawings to describe various embodiments.

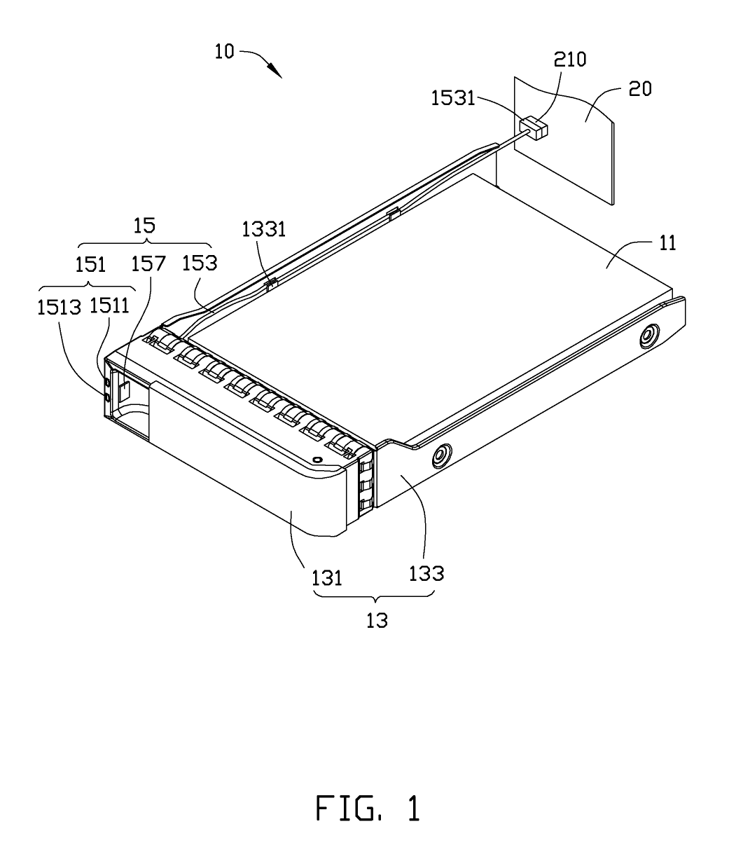

FIG. 1 shows an isometric view of a hard disk drive module 10. The hard disk drive module 10 is arranged within an electronic device, such as a computer, a server, or the like. The electronic device can comprise a plurality of hard disk drive modules 10. Each hard disk drive module 10 comprises a hard disk drive 11, a bracket 13, and an indicating device 15.

The bracket 13 supports and fixes the hard disk drive 11 in the electronic device. The bracket 13 is substantially U-shaped and comprises a main body 131 and two arms 133 extending from opposite ends of the main body 131. The two arms 133 are substantially parallel to each other and substantially perpendicular to the main body 131. The hard disk drive 11 is located between the two arms 133. The bracket 13 further comprises a plurality of hooks 1331 protruding from an inner surface of each arm 133.

The indicating device 15 comprises an indicating unit 151, a cable 153, and a processor 157. The processor 157 is arranged on the main body 131. The processor 157 is electrically connected to a control system 20 via the cable 153. The cable 153 extends along one arm 133. The indicating unit 151 indicates a working status of the hard disk drive 11. The control system 20 is electrically connected to the hard disk drive 11. The control system 20 detects a working status of the hard disk drive 11 and transmits a status message to the processor 157 via the cable 153. The processor 157 controls the indicating unit 151 to indicate the working status of the hard disk drive 11 according to the status message. The working status can be an active status, an inactive status, or a faulty status, for example. The control system 20 can be arranged on a backplane of the hard disk drive 11 or on a motherboard of the electronic device, and the control system 20 detects the working status of the hard disk drive 11 via the hard disk drive backplane or the motherboard.

The cable 153 extends from the main body 131 to the control system 20. One end of the cable 153 is electrically connected to the indicating unit 151, while another end of the cable 153 comprises a connector 1531. The connector 1531 is plugged into a slot 210 of the control system 20 to electrically connect the indicating unit 151 to the control system 20. Both the connector 1531 and the slot 210 comprise a plurality of connection pins to establish an electrical connection therebetween. The cable 153 is secured on one arm 133 by the hooks 1331 of the bracket 13. The processor 157 is electrically connected to the control system 20 via the cable 153, the connector 1531, and the slot 210.

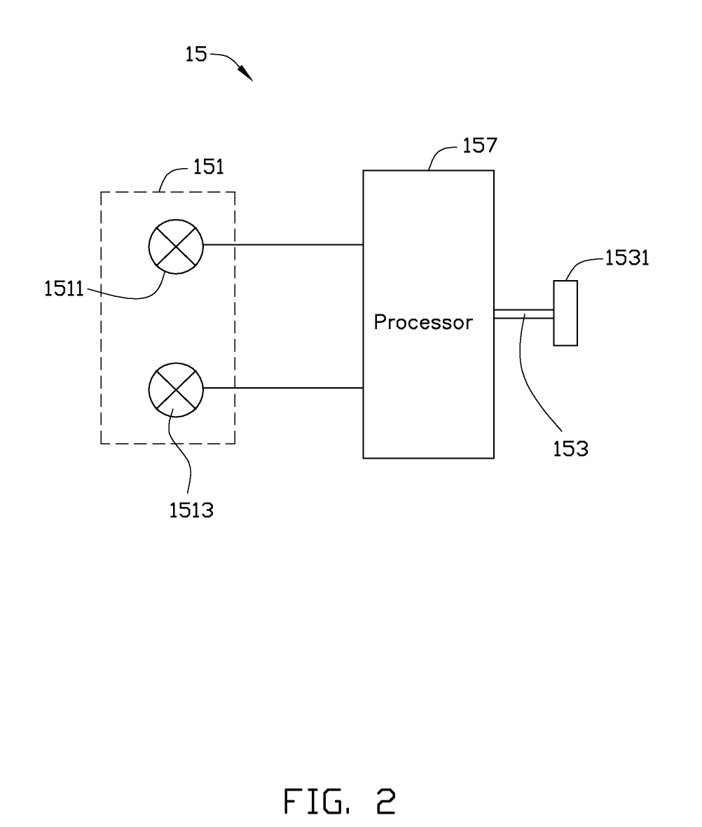

FIG. 2 shows a schematic circuitry diagram of the indicating device 15. The indicating unit 151 comprises a first indicator 1511 and a second indicator 1513. The first indicator 1511 and the second indicator 1513 are both electrically connected to the processor 157. The processor 157 encodes the status message to control the first and second indicator 1511 and 1513 to indicate the working status of the hard disk drive 11. In the embodiment, the processor 157 is a complex programmable logic device (CPLD). The control system 20 outputs a serial general purpose input/output (SGPIO) signal comprising the status message to the processor 157. The cable 153 is a SGPIO bus.

The first indicator 1511 and the second indicator 1513 can be light-emitting diode (LED) indicators. The first indicator 1511 and the second indicator 1513 are located at a front side of the main body 131 visible to users. Two through holes (not labeled) are defined in the main body 131 for showing the first indicator 1511 and the second indicator 1513, respectively. The first indicator 1511 emits a first predetermined color (e.g., green) of light when the hard disk drive 11 is in the active status and exchanges data with an external electronic device such as a computer. The first indicator 1511 does not emit any light when the hard disk drive is in the inactive status. The second indicator 1513 emits a second predetermined color (e.g., red) of light if the hard disk drive 11 is in the faulty status, which indicates that the hard disk drive 11 needs to be repaired or replaced.

In summary, the first indicator 1511 and the second indicator 1513 are located at the front side of the bracket 13 visible to the user, so that the user can readily know the status of the hard disk drive 11 such as the active state, inactive state, or faulty state. Therefore, the indicating device 15 of the present disclosure is advantageous over conventional light guide pipes.

It is to be understood that even though numerous characteristics and advantages of the present embodiments have been set forth in the foregoing description, with details of the structures and functions of the embodiments, the disclosure is illustrative only; and changes may be in detail, especially in the matters of arrangement of parts within the principles of the embodiments to the full extent indicated by the broad general meaning of the terms in which the appended claims are expressed.

What is claimed is:

1. A hard disk drive module, comprising:
a hard disk drive;
a bracket supporting the hard disk drive; and
an indicating device indicating a working status of the hard disk drive, wherein the indicating device comprises an indicating unit and a processor, the processor is connected to a control system to encode a status message transmitted by the control system via a cable and control the indicating unit to indicate the working status of the hard disk drive, and the status message indicates the working status of the hard disk drive.

2. The hard disk drive module of claim 2, wherein the working status comprises an active status, an inactive status, and a faulty status.

3. The hard disk drive module of claim 2, wherein the first indicator emits a first predetermined color of light when the hard disk drive is in the active status and exchanges data with an external electronic device.

4. The hard disk drive module of claim 2, wherein the first indicator is turned off if the hard disk drive is in the inactive status.

5. The hard disk drive module of claim 2, wherein the second indicator emits a second predetermined color of light if the hard disk drive is in the faulty status.

6. The hard disk drive module of claim 1, wherein the bracket comprises a main body and two arms extending outwardly from opposite ends of the main body, and the two arms are substantially parallel to each other and substantially perpendicular to the main body.

7. The hard disk drive module of claim 6, wherein the first indicator and the second indicator are located at a front side of the main body of the bracket, and the processor is arranged on the main body.

8. The hard disk drive module of claim 7, wherein the cable extends from the main body to the control system along one of the arms and is fixed by a plurality of hooks protruding from an inner surface of each arm.

9. The hard disk drive module of claim 1, wherein the processor is a complex programmable logic device (CPLD).

10. A hard disk drive module, comprising:
a hard disk drive;
a bracket supporting the hard disk drive; and
an indicating device indicating a working status of the hard disk drive, wherein the indicating device comprises an indicating unit, a processor, and a cable, one end of the cable is connected to the processor, and the other end of the cable of the cable connected to a control system, the processor encodes a status message transmitted by the control system via the cable and control the indicating unit to indicate the working status of the hard disk drive.

11. The hard disk drive module of claim 10, wherein the working status comprises an active status, an inactive status, and a faulty status.

12. The hard disk drive module of claim 11, wherein the first indicator emits a first predetermined color of light when the hard disk drive is in the active status and exchanges data with an external electronic device.

13. The hard disk drive module of claim 11, wherein the first indicator is turned off if the hard disk drive is in the inactive status.

14. The hard disk drive module of claim 11, wherein the second indicator emits a second predetermined color of light if the hard disk drive is in the faulty status.

15. The hard disk drive module of claim 10, wherein the bracket comprises a main body and two arms extending outwardly from opposite ends of the main body, the two arms are substantially parallel to each other and substantially perpendicular to the main body.

16. The hard disk drive module of claim 15, wherein the first indicator and the second indicator are located at a front side of the main body of the bracket, and the processor is arranged on the main body.

17. The hard disk drive module of claim 16, wherein the cable extends from the main body to the control system along one of the arms and is fixed by a plurality of hooks protruding from an inner surface of each arm.

18. The hard disk drive module of claim 10, wherein the processor is a complex programmable logic device (CPLD).
